(19) United States
(12) Patent Application Publication
(10) Pub. No.: US 2004/0107274 A1
(43) Pub. Date: Jun. 3, 2004

(54) Policy-based connectivity

(76) Inventors: Steven J. Mastrianni, Unionville, CT (US); Thomas E. Chefalas, Somers, NY (US); David Frederick Bantz, Chappaqua, NY (US)

Correspondence Address: Thomas A. Beck, 26 Rockledge Lane, New Milford, CT, 06776, US

(21) Appl. No.: 10/308,665

(22) Filed: Dec. 3, 2002

(51) Int. Cl. G06F 15/173

(52) U.S. Cl. 709/223; 709/227

(57) ABSTRACT

The system disclosed uses policy directives to establish and regulate connectivity on a computer system. A policy profile is applied to the computer system that determines how and when connections can be made, and the devices on which the connections can be made.

### BACKGROUND OF THE INVENTION

1. Field of Invention

The present invention relates to a system and method for policy-based connectivity.

2. Description of the Related Art

Technology and the pressures of the global marketplace have forever changed the way people work. Just a few years ago, work was defined in the context of an 8-hour day or 40-hour week on a company's premises. High energy costs and long commute times have caused high tech companies to adopt new ways to make workers more productive. One of the most popular initiatives has been telecommuting, or the ability to work from home or from a remote location.

Each of these scenarios requires access to data. This data might be the company's latest price figures, inventory, or customer records, or perhaps the latest drop of source code. It might also include confidential financial information or personnel data that must be kept secure. To insure that the data is accessible only by individuals with the proper credentials, the data is often encrypted before being sent and later decrypted using a pair of keys that only the sender and receiver know about.

In larger companies, the IT “shops,” as they are called, control the access to the company network and data by specifying the network software and hardware components that comprise the network, and by providing network access verification through the use of IDs, passwords, and accounts. These “shops” might specify, for example, that a user's password must be at least 8 characters long with at least one numeric character; or that a password cannot contain more than two letters of the users first name. They might also specify that the user never connect using a wireless protocol that does not have the proper security methods in place, as defined by the corporate IT policy.

While some of these mandates can be implemented in hardware and software installed on the user's machine, many of the directives can be avoided with a little effort, which might allow confidential information to be received or monitored by some unauthorized person on the network.

If a local area network is available, users can attempt to use a public network to get connected. If there is no local network, users can try to use a POTS connection, or perhaps try a wireless network or cellular connection. Some of these connections can pose a security risk, violate a company policy or directive, or result in large phone bills. Certain types of adapters may not be available at certain times, or users may want to select a particular adapter as a personal preference.

Without a uniform set of policies for connecting to a network, a company risks exposing its confidential information to unauthorized users, network hackers, or others listening on the network.

### SUMMARY OF THE INVENTION

The present invention uses policy directives to establish and regulate connectivity on a computer system.

A policy profile is applied to the computer system that determines how and when connections can be made, and the devices on which the connections can be made.

The policy also establishes the type of security required; such as public or private keys, encryption and decryption algorithms and keys, adapter types, and connection medium. The policy may also be location-based, allowing different policies to be active at different locations, and allowing certain conditions when those policy directives may be overridden. Policies may be created or changed by a company's IT organization, or even placed on an internal corporate web site for download.

The policy dictates how a particular connection can be made. If a user of a computer system attempts to make a connection, a policy engine determines if the criteria have been met to allow the connection to take place. If the criteria have been met, the connection attempt can proceed. If the criteria have not been met, the user is prompted to enter the missing security information, such as a password or key. The information is then saved for subsequent use. It is possible that the policy states that a particular value or values cannot be cached, but must be entered each time the user attempts to connect.

Policies are published and edited using a Policy Editor. The Policy Editor allows the computer user to enter and edit the information comprising the policy, which is then sent or preloaded onto each system, or placed on a web site for later download and deployment. The user may view the policy, but only an administrator is allowed to change to policy.

The following are examples of the policy enforced by the policy engine:

Only connect on wireless networks that support Cisco LEAP protocol.

Never connect to a network using CDMA.

Passwords must be changed every 90 days.

Users are not allowed to connect to the following web sites: [listed . . . ]

Users are not allowed to use the following wireless networks: [listed . . . ]

No wireless connections allowed.

Always choose the fastest connection (favor speed over cost).

Always choose the most economical connection (favor cost over speed).

### BRIEF DESCRIPTION OF THE DRAWINGS

FIG. 1 illustrates a component block diagram of the present invention.

FIG. 2 illustrates a sample policy schema file.

FIG. 3 illustrates a typical computer system upon which the invention may be installed.

### DETAILED DESCRIPTION OF THE PREFERRED EMBODIMENT OF THE PRESENT INVENTION

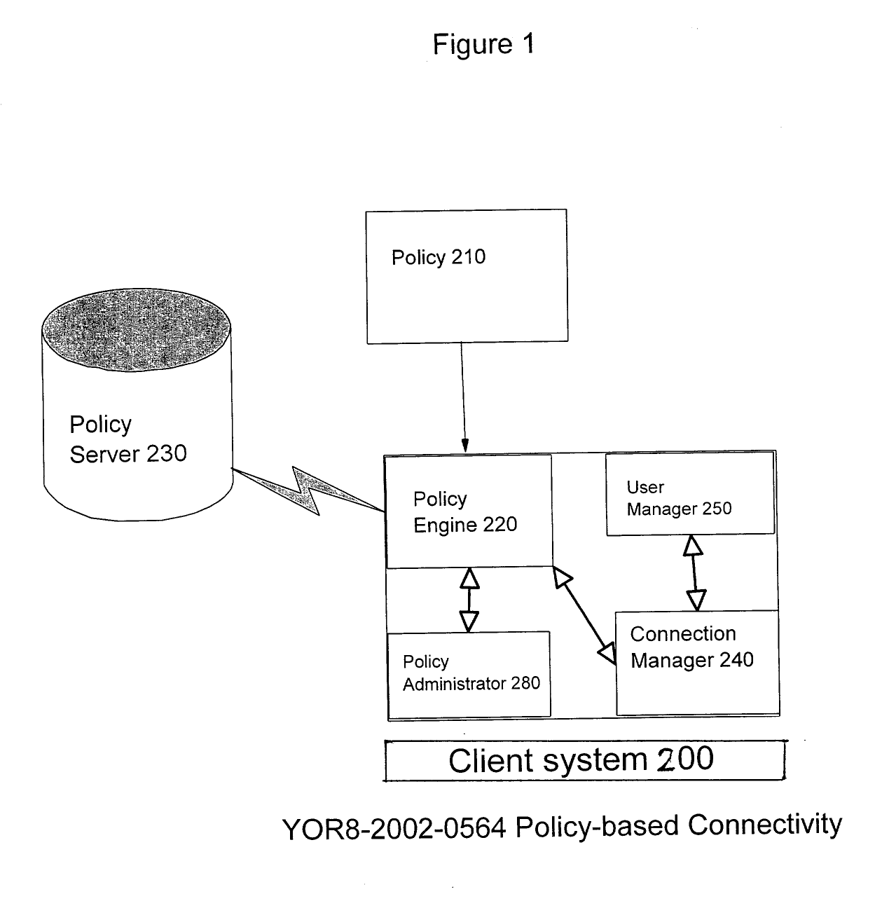

Referring to FIG. 1, the present invention relates to a system and method for policy-based connectivity, and consists of a Policy Engine 220, a policy schema file 210, an optional Policy Server 230, and a Policy Administrator 280. These components, when installed on a computer system 200, working together with a computer's operating system and applications, provides a method and apparatus for determining how and when a user is permitted to access network connections from a computing device (policy).

The present invention, through use of Policy Schema 210 and Policy Engine 220 establishes and enforces a set of policies that determine how and when a system may be connected to a network. The policies are specified and encapsulated in policy schema file 210 (the policy database), which includes standards, priorities, security requirements, speed, and other characteristics, and determines how a user can get connected to a particular network and the operations that the user can perform while on that network.

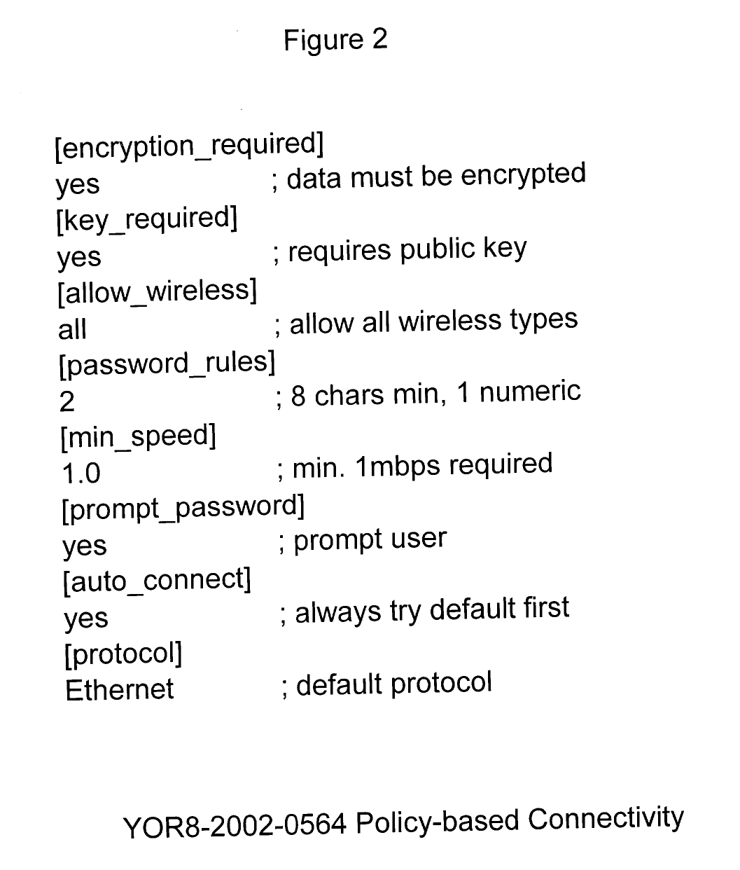

For example, if a user was connected to a public network, the user might be forbidden to visit pornographic web sites or to download objectionable material. If they connect using a wireless network, they may be forbidden from downloading certain company documents deemed unsafe over the wireless connection. These actions are set by policy 210 and enforced by policy engine 220. The policy schema 210 (an illustrative example of which is depicted in FIG. 2) may be preloaded on the users system, installed via a network or storage device, or downloaded from policy server 230. The policy format is kept hidden from the user and is encrypted to prevent unauthorized access or tampering.

A mobile or remote user can connect to a wired or wireless network manually by invoking a dialer or network logon application, or automatically when the user's computer system 200 detects the ability to connect to a network because of the presence of a wired connection (e.g., a network cable is plugged in) or a wireless connection (a wireless access point is detected). Whether the connection is attempted in an automated or a manual fashion, the portion of the operating software upon which the invention is installed is invoked to create and make the connection. For purposes of describing this invention, this component is described and depicted in FIG. 1 as the Connection Manager 240. The actual type of Connection Manager provided or the “look and feel” of the Connection Manager 240 may differ substantially, depending on the type of connectivity or operating system software installed on the user's computer. The present invention “hooks” the system Connection Manager 240 so that all connection requests, either automatic or manual, are routed through Policy Engine 220, when the user attempts to connect to a wired or wireless network, the system's Connection Manager 240 usually first enumerates the connections available to the user. Depending on the user's preferences, computer system 200 may allow the user to select one of the available connections, or the system itself will select one of the available connections automatically for the user, based on the current policy. Connection Manager 240 verifies that the user has the proper rights and privileges to make the connection. If the user has the correct privileges, Connection Manager 240 then attempts to make the connection using the selected protocol, device, and security constraints as defined in Policy Schema 210.

Some policies may require the user to interactively enter some information, such as a password or encryption key, to continue with a connection. If the user needs to enter any information as called for in the policy, Connection Manager 240 will pause and present the proper dialog(s) to allow the user to enter the information. The Policy Engine 220 through the services of Connection Manager 240 keeps a detailed log of all connection attempts, successes and failures, length of time connected, and other information such as the number of bytes transmitted and received, the average throughput, information about the policies that were applied, and other relevant network information. This information is used to diagnose any problems encountered when attempting to connect, and also provides a detailed audit trail of the connections and length of each connection, URLs accessed, information downloaded, and other useful information and parameters.

This information is then later optionally used by Policy Administrator 280 to customize the policy settings on a per-location basis to achieve a desired result, such as the method that provided the best throughput when connecting to the company's sales server from the Boston area.

Referring to FIG. 2, the policy schema referred to above is encapsulated in a file, and examples of the elements found in a policy schema is shown. The format of the file in FIG. 2 is set forth for illustrative purposes only. There are many ways to express parameters associated with certain conditions or criteria, and the file is shown to show one way that policy can be expressed. Other ways to express such policy are well-known and obvious to those skilled in the art. While the present invention requires that a policy be incorporated to effect the operation of the present invention, the exact format of the policy file or data is not integral to the operation of the present invention and is well known to others skilled in the art.

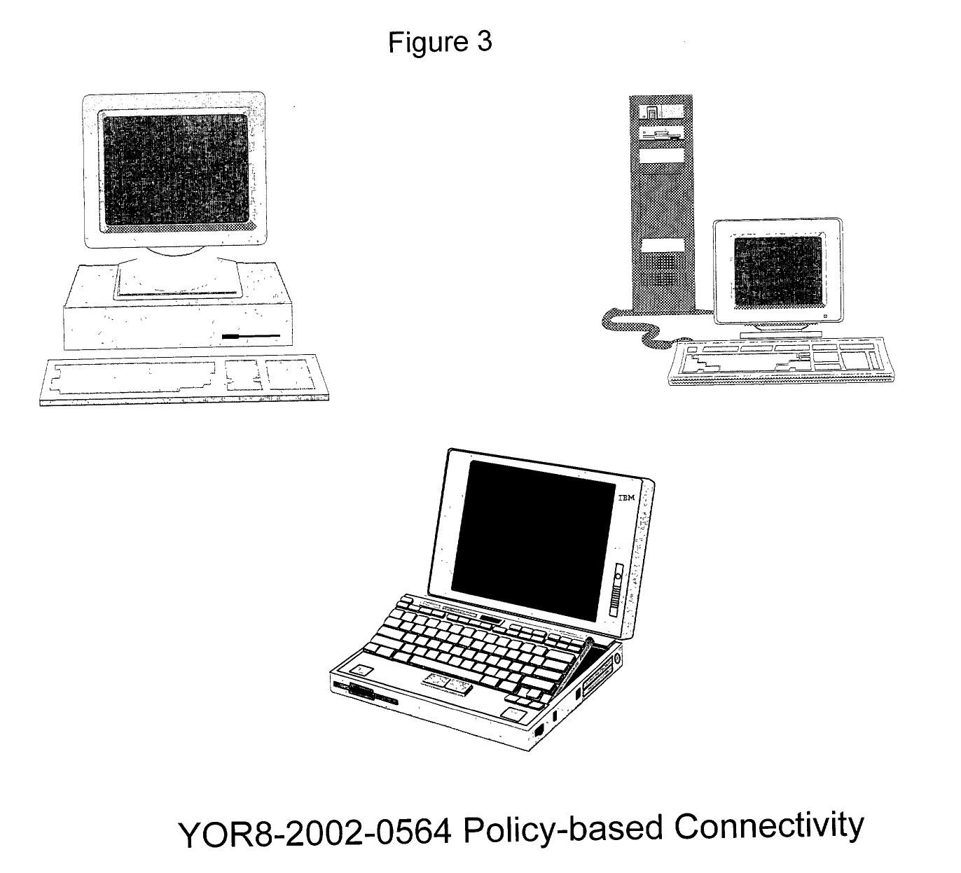

FIG. 3 illustrates one type of computer system upon which the present invention may be installed. Other computer systems upon which the present invention may be installed include handheld devices, pocket organizers, cell phones, intelligent pagers, set-top boxes, notebook computers, and any other type of computing device.

What we claim and desire to protect by Letters Patent is:

1.) A system using one or more policy directives to establish and regulate connectivity from a user's computer comprising:
applying a policy schema file containing Policy Settings, establishing desired criteria, to said user's computer, resulting in a Policy Engine which determines if said criteria are met to allow a connection to take place;
when said user attempts to connect to a wired or wireless network, either manually or automatically, via said user's computer, said computer enumerates the possible connections available to said user; and
depending upon Policy Settings in said policy schema file, which Policy Settings are read and interpreted by said Policy Engine; and
depending upon said user's preference, and based upon said criteria in said policy engine, said system:
a) allows said user to select one of the available connections, or
b) selects an available connection automatically for said user;
in either event, said policy manager determines whether said user has the proper rights and privileges to make said connection based upon said criteria embodied in said policy manager; and,
if said user does not have said proper rights and privileges, no connection is attempted; or
if said user has said proper rights and privileges, in such event, said policy manager makes said connection using the connection manager portion of said user's computer system.

2.) The system defined in claim 1 which further includes the step of entry by said user of any information required by said policy engine, whereupon said policy manager presents proper dialog to enable said user to enter the requested information.

3.) The system defined in claim 2 wherein said policy manager keeps a record of all connection attempts, successes, failures, length of time connected, number of bytes transmitted and received, average throughput, information about policies that were applied and all network information.

4.) The system defined in claim 3 wherein said policy schema file includes standards, priorities, security requirements, speed, operations that may be performed on the network.

5.) The system defined in claim 3 wherein said policy schema file has been previously initialized by said user's company IT or technology organization and placed on said user's computer by said company or downloaded to said user's computer from an optional policy server.

6.) The system defined in claim 3 wherein said policy manager records the details of each connection and optionally “learns” the best connectivity settings by saving the results and using those results to automatically update said policy.

7.) The system claimed in claim 6 wherein said “learned” settings are manually or automatically applied to said policy schema file to insure that the best possible settings are used to provide said connection.

8.) The system defined in claim 4 wherein said policy schema file has been previously initialized by said user's company IT or technology organization and placed on said user's computer by said company or downloaded to said user's computer from an optional policy server.

9.) The system defined in claim 8 wherein said policy manager records the details of each connection and “learns” the best connectivity settings by saving the results.

10.) The system claimed in claim 9 wherein said “learned” settings are manually or automatically applied to said policy schema file to insure that the best possible settings are used to provide said connection.

11.) The system defined in claim 1 wherein said Policy Settings are specified or mandated by corporate policy.
